(19) United States
(12) Patent Application Publication
(10) Pub. No.: US 2003/0041431 A1
(43) Pub. Date: Mar. 6, 2003

(54) Bearing cup extraction tool

(76) Inventor: Frederick L. Heflin, Evington, VA (US)

Correspondence Address: KIMBERLY A CHASTEEN, WILLIAMS MULLEN CLARK & DOBBINS, ONE IOD OYSTER POINT ROAD, SUITE 210, NEWPORT NEWS, VA, 23602

(21) Appl. No.: 09/938,164

(22) Filed: Aug. 23, 2001

(51) Int. Cl. B23P 19/04

(52) U.S. Cl. 29/263

(57) ABSTRACT

This invention is a specialized tool to extract bearing cups from wheel hubs on vehicles. Typically, conventional means to extract bearing cups would be to use a device that includes striking the device with a hammer or punch. Such an extraction could damage the wheel hub or the bearing cup. Other means exist utilizing complex, hard to use, mechanical devices. This invention is a simple, non-impact type bearing cup extraction tool utilizing a rod and specialized extraction elements. The extraction elements work along the rod to extract the bearing cups safely without impacting the bearing cups.

### RELATED APPLICATION

The present invention is related to the invention described in co-owned, co-pending patent application Ser. No. 09/413,085 filed on Oct. 6, 1999.

### BACKGROUND OF THE INVENTION

1. Field of the Invention

The present invention relates generally to an apparatus for extracting a bearing cup and, more particularly, to an apparatus for extracting bearing cups for bearings in wheel hubs of vehicles.

2. Description of the Related Art

As anyone who performs a lot of mechanical work will attest, nothing beats having the proper tool for a job. The proper tool can save time, save money, produce a higher quality job, reduce damage to equipment, and provide for the increased safety of the worker. Each field of mechanical work has its own type of specialty tools, each performing a specialized task. One field where there has been a need for such a specialized tool is in the repair of wheel bearings for vehicles, particularly the extraction of bearing cups. Bearing cups used for bearings often have to be replaced on a regular basis with such units. In the past one method of extracting such stops has included hitting them with a hammer or punch. Needless to say, such a method can easily damage the cup or the hub in which it is mounted. Such damage can be extremely costly. Additionally, the action of hitting the bearing with a hammer or punch puts the worker at increased risk of physical injury, should the bearing cup fly out of the hub.

In the related art, there exist many patents for various devices and methods for installing bearings, seals, gears, impellers, bushings and sprockets. Only two patents were found that even discuss bearing cups for wheel bearings and the like. U.S. Pat. No. 4,505,689 issued to Mazziotti discloses a mounting for a bearing cup of a universal joint but does not disclose a tool for extracting a bearing cup.

U.S. Pat. No. 4,429,447 issued to Davis discloses a bearing cup installation tool. However, nowhere in the Davis reference does it address extraction of the bearing cups. The device in Davis appears to be of a universal design to allow the installation of bearing cups of varying diameters in vehicles of all sorts. Further, the Davis design has a cross head with three pairs of radially extending arms for engaging an outer end of the bearing cup and a driving handle, whereby driving force imparted by a hammer, struck against an end of the driving handle, drives the bearing cup into the opening.

The present invention differs from Davis in many respects. First of all, the present invention uses a design which forces the bearing cups from the bearing hub. This eliminates the need for a driving force from the use of a hammer or other instrument. Whenever a driving force delivered by impact is delivered, the potential for damaging the bearing cup or bearing hub is always present. The present invention eliminates this problem by allowing one to slowly and controllably force the bearing cup from the hub. The present invention also can accommodate bearing cups and hubs of varying diameters but it accomplishes this without requiring the use of a bulky and mechanically complex expanding radial arm assembly.

Accordingly, there is a need for a less complicated device and method by which an individual can quickly and easily extract bearing cups for bearings from the wheel hubs of vehicles without risk of damage or injury. The development of the Bearing Cup Extraction Tool fulfills this need.

A search of the prior art did not disclose any patents that read directly on the claims of the instant invention; however, the following references were considered related:

| U.S. Pat. No. | Inventor | Issue Date |
|---|---|---|
| 4,339,865 | Shultz | Jul. 20, 1982 |
| 2,775,025 | Williams | Dec. 25, 1956 |
| 5,836,078 | Aiken et al. | Nov. 17, 1998 |
| 4,646,412 | Fade | Mar. 3, 1987 |
| 4,505,689 | Mazzioti | Mar. 19, 1985 |
| 4,429,447 | Davis | Feb. 7, 1984 |
| 4,173,813 | Stockinger | Nov. 13, 1979 |
| 3,942,234 | Kepler | Mar. 9, 1976 |

### SUMMARY OF THE INVENTION

A tool for extracting bearing cups from the wheel hub of a vehicle is provided which includes a rod and at least two extraction elements. The extraction elements can be installed on the rod, for example, through a threaded aperture in the center of the extraction element which is mated with threads on the outer surface of the rod. Alternatively, a threaded nut can be installed in an aperture in the center of the extraction element and the threaded nut can then mate with threads on the outside of the rod. Each extraction element includes a piece which is capable of abutting against the internal surface of the bearing cups to be removed such as a spring-loaded button. If such a spring-loaded button is used, it may have a tapered edge and is constructed such that a forced is needed to push the button inside the extraction element. The tool further includes means for moving the extraction elements along the rod towards and away from each other during the extraction process. For example, if a threaded rod is used, the threads may be in opposite directions at the opposite ends of the rod so that the extraction elements move in opposite directions depending on which way the rod is rotated or pressed by mechanical, electrical or hydraulic means or other method as appropriate. If desired, the rod can be of one diameter at one end and of a different diameter at the other end to ensure proper installation of the extraction elements. A hydraulic cylinder can be used as the rod if appropriate. The tool may also include a support bar installed on the rod and removably attached to the wheel hub from which the bearing cups are being extracted for added stability.

It is therefore an object of the present invention to provide an improved bearing cup extraction tool.

It is another object the present invention to provide a bearing cup extraction tool that extracts bearing cups from wheel hubs of vehicles.

It is yet another object of the present invention to provide a bearing cup extraction tool which eliminates or reduces the risk of injury.

It is still yet another object of the present invention to protect bearing surfaces and bearing cup surfaces while extracting bearing cups.

It is yet still another object of the present invention to be quick and easy to use.

Briefly described according to one embodiment of the present invention, the Bearing Cup Extraction Tool, as its name implies, is a specialized tool to extract bearing cups from wheel hubs on vehicles. The tool accomplishes this task with a minimum of effort and without hitting the bearing cups with a hammer, which can damage them beyond repair. A rod is inserted through the hub and the bearing cups. Next, specially designed bearing cup extractors are added to each end of the rod. The bearing cup extractors are forced towards each other, eventually moving inside of the bearing cups. Each bearing cup extractor includes an element which extends beyond the diameter of the bearing cups once the extractors have moved inside the bearing cups. The extractors are then forced away from each other subsequently forcing the bearing cups from the wheel hub.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a view of the inner surface of the extraction element of a Bearing Cup Extraction Tool, according to the preferred embodiment of the present invention;

FIG. 2 is a view of the outer surface of the extraction element of a Bearing Cup Extraction Tool, according to the preferred embodiment of the present invention;

FIG. 3 is a side view of the extraction element of a Bearing Cup Extraction Tool, according to the preferred embodiment of the present invention; and

FIG. 4-6 are top views of the Bearing Cup Extraction Tool and its contemplated usage in the wheel hub of a vehicle, according to the preferred embodiment of the present invention.

### LIST OF REFERENCE NUMBERS

| | |
|---|---|
| 10 | extraction element |
| 10a | extraction element |
| 12 | aperture |
| 14 | spring-loaded button |
| 16 | nut |
| 18 | rod |
| 20 | bearing cup |
| 20a | bearing cup |

### DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention.

1. Detailed Description of the Figures

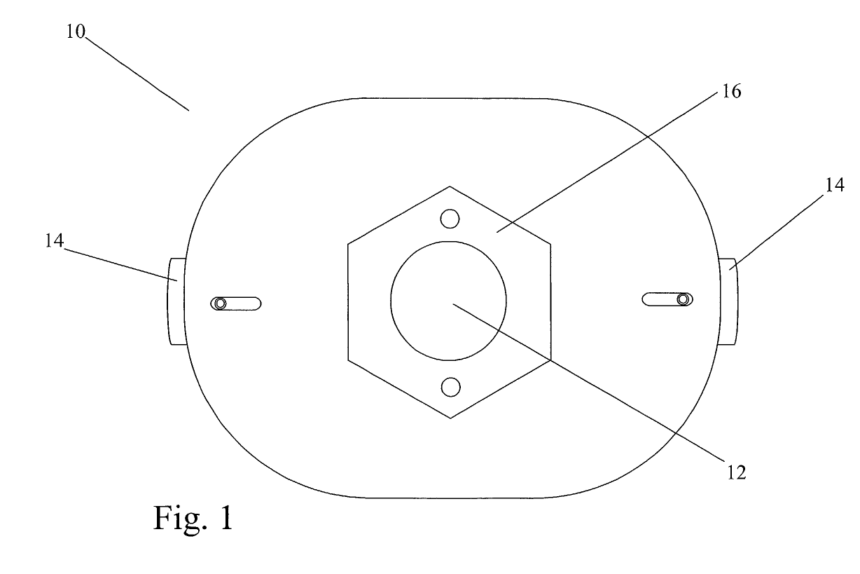

Referring now to FIG. 1, shown is a view of the inner surface of one of the extraction elements 10 of the Bearing Cup Extraction Tool. The extraction element 10 is composed of a flat, generally annular shaped disc with an aperture 12 in the center and is placed on one side of a wheel hub. A mirror image of the extraction element 10 is placed on the other side of the wheel hub. While the extraction element is shown as generally circular with a flat top and bottom, clearly alternative shapes are contemplated. Different sized extraction elements can be used for wheel hubs having different sized bearing cups.

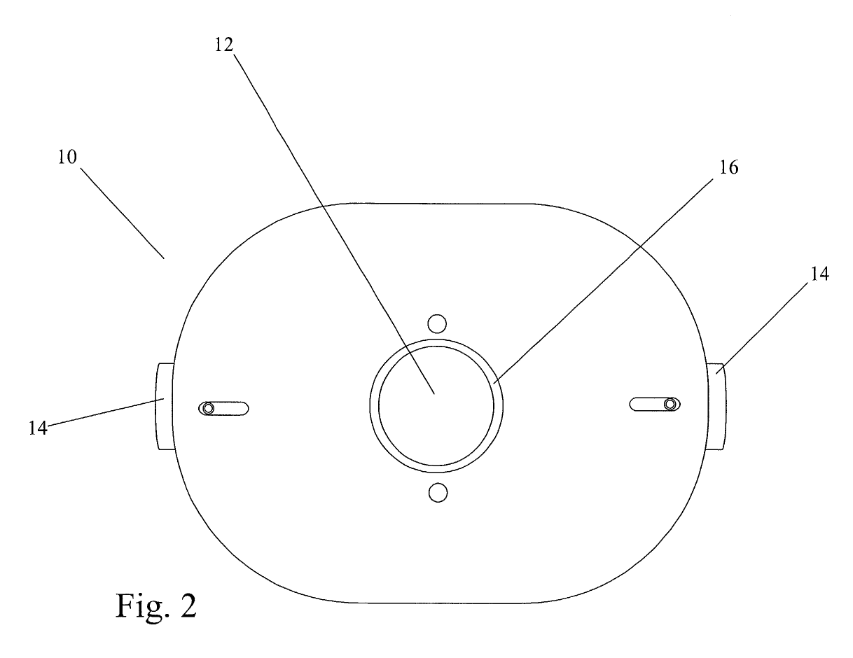

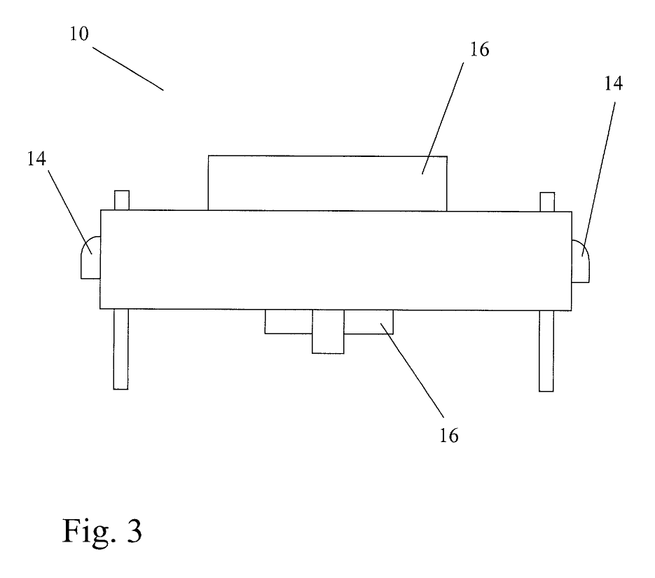

The sides of the extraction element 10 include spring-loaded buttons 14. The spring, located internal to the extraction element 10, biases the buttons 14 away from the center of the extraction element 10 such that a force is required to drive the buttons 14 inside the extraction element 10. In this particularly preferred embodiment, a hexagonally shaped nut 16 is bolted to the extraction element 10 and passes through the center aperture 12. In the preferred embodiment shown in the drawings, the nut 16 is threaded to allow a threaded connection with a rod 18. FIG. 2 shows the outer surface of the extraction element 10. FIG. 3 shows a side view of the extraction element 10. As can be seen, the spring-loaded buttons 14 are tapered on one edge.

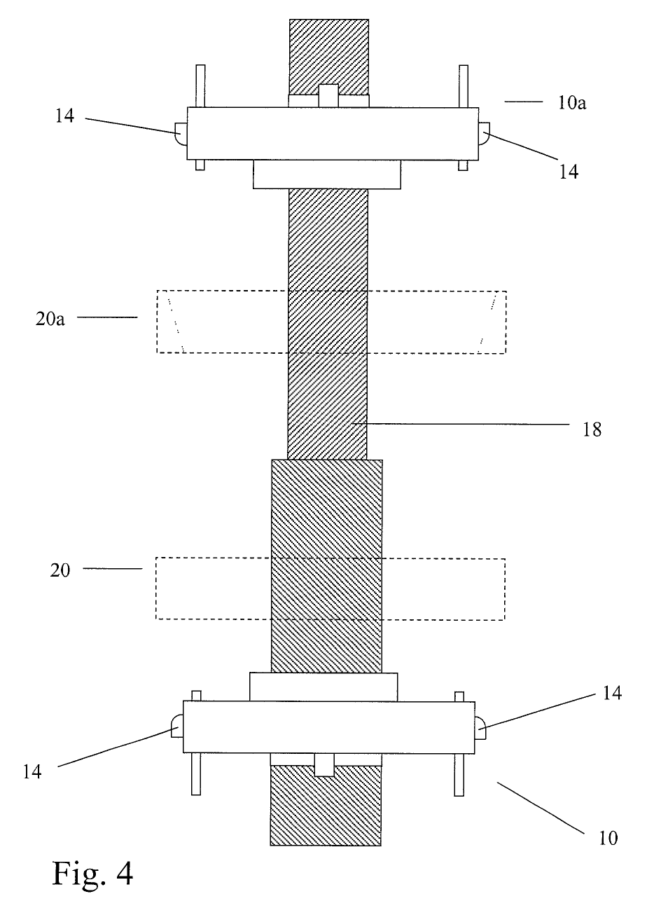

A rod 18 (shown in FIGS. 4-6) is generally cylindrical in shape. In the preferred embodiment shown in the drawings, the rod 18 is threaded. One end of the rod 18 may be of a larger diameter than the other end. This particularly preferred characteristic facilitates use of the extraction tool as the apertures 12 of the extraction elements 10 and 10a can be sized accordingly so that the tool can quickly and easily be constructed in the correct configuration for use. This construction ensures that the correct extraction element 10, 10a is placed on the correct end of the rod 18 such that the tapered portion of the buttons 14 is facing the correct way. The length of rod 18 depends on the width of the wheel hub which varies from manufacturer to manufacturer. Although there is no specific diameter of rod 18 required, it must be of large enough diameter to withstand the forces exerted on it while urging extraction elements 10 and 10a into the cavity of the wheel hub. It must not be of such a large diameter that it will not fit through the hollow center of the bearing cups 20 and 20a or the apertures of the extraction elements 10 and 10a.

In a further preferred embodiment, the bearing cup extraction device includes a support bar. The support bar is temporarily attached to the wheel hub to ensure that the rod 18 and extraction elements 10 and 10a remain centered in the wheel hub. Additionally, if one extraction element 10 or 10a successfully extracts the bearing cup 20 or 20a before the other extraction element 10 or 10a, the support bar provides the stability necessary so that the second extraction element 10 or 10a can complete the extraction of the second bearing cup 20 or 20a.

2. Operation of the Preferred Embodiment

FIGS. 4-6 show the extraction tool in use. To use the present invention, one selects the appropriate sized inner and outer extraction elements 10, 10a and threaded rod 18. In FIG. 4, two generally mirror image extraction elements 10 and 10a are threaded onto threaded rod 18 with the extraction elements on opposite sides of the wheel hub (not shown) and, more particularly, on opposite sides of the bearing cups 20 and 20a to be extracted. The threaded rod 18 is then manipulated mechanically, electrically or hydraulically to force the extraction elements 10 and 10a towards the bearing cups 20 and 20a to be extracted. For illustration purposes, the outside edges of the bearing cups 20 and 20a are shown by dashed lines while the inside surfaces are shown by dotted lines.

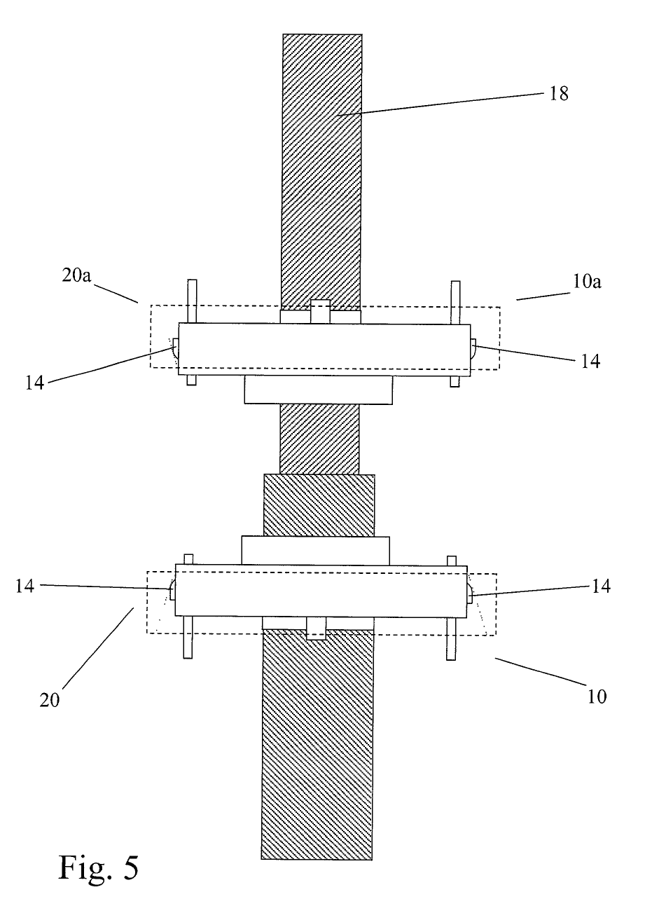

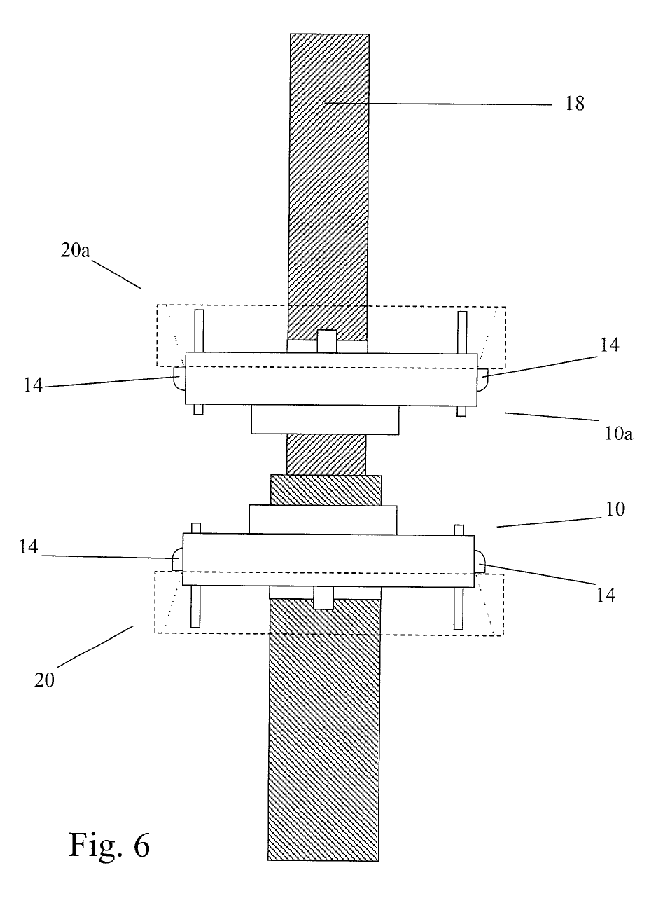

FIG. 5 shows that as the extraction elements 10 and 10a are driven towards each other by the rod 18, the spring-loaded buttons 14 are forced inwards by the internal surfaces of the bearing cups 20 and 20a. As shown in FIG. 6, once the spring-loaded buttons 14 move past the bearing cups 20 and 20a, the spring-loaded buttons 14 are free to return to their normal resting state. Once both extraction elements 10 and 10a have been driven far enough to allow the spring-loaded buttons 14 to move as shown in FIG. 6, the extraction elements 10 and 10a are then driven away from each other. When the extraction elements 10 and 10a are forced in this direction, the spring-loaded pins 14 abut against the bearing cups 20 and 20a, forcing them from their installed configuration. The spring-loaded buttons 14 pull the bearing cups 20 and 20a away from the wheel hub and thus the bearing cups 20 and 20a are extracted.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A tool for extracting bearing cups from the wheel hub of a vehicle, comprising:
a rod having an outer surface and first and second ends;
at least two extraction elements capable of being installed on opposite ends of the rod, each extraction element having:
an inner surface,
an outer surface,
an aperture formed in the center, the aperture having an inner surface, and
at least one element which is capable of abutting against the internal surface of the bearing cups to be removed;
a means for decreasing the distance between the extraction elements installed on the rod; and
a means for increasing the distance between the extraction elements installed on the rod.

2. A tool for extracting bearing cups from the wheel hub of a vehicle as described in claim 1, wherein the rod is threaded.

3. A tool for extracting bearing cups from the wheel hub of a vehicle as described in claim 1, wherein the rod is threaded in one direction at the first end and threaded in the opposite direction at the second end.

4. A tool for extracting bearing cups from the wheel hub of a vehicle as described in claim 1, wherein the rod is of a first diameter at the first end and of a second diameter at the second end, wherein the first and second diameters are not equal.

5. A tool for extracting bearing cups from the wheel hub of a vehicle as described in claim 1, wherein the rod is a hydraulic cylinder.

6. A tool for extracting bearing cups from the wheel hub of a vehicle as described in claim 1, wherein the extraction elements further include a nut installed in the aperture.

7. A tool for extracting bearing cups from the wheel hub of a vehicle as described in claim 6, wherein the nut installed in the aperture is threaded.

8. A tool for extracting bearing cups from the wheel hub of a vehicle as described in claim 1, wherein the element which is capable of abutting against the internal surface of the bearing cups to be removed is a button.

9. A tool for extracting bearing cups from the wheel hub of a vehicle as described in claim 8, wherein one edge of the button is tapered.

10. A tool for extracting bearing cups from the wheel hub of a vehicle as described in claim 8, wherein the button is spring-loaded such that the button is forced outwardly away from the center of the extraction element.

11. A tool for extracting bearing cups from the wheel hub of a vehicle as described in claim 1, wherein the means for decreasing the distance between the extraction elements installed on the rod comprises:
the first end of the rod being threaded in one direction and the second end of the rod being threaded in the opposite direction;
the inner surface of the apertures being threaded; and
a means for rotating the rod.

12. A tool for extracting bearing cups from the wheel hub of a vehicle as described in claim 11, wherein the means for rotating the rod is a method selected from the group consisting of mechanical, electrical or hydraulic.

13. A tool for extracting bearing cups from the wheel hub of a vehicle as described in claim 1, wherein the means for increasing the distance between the extraction elements installed on the rod comprises:
the first end of the rod being threaded in one direction and the second end of the rod being threaded in the opposite direction;
the inner surface of the apertures being threaded; and
a means for rotating the rod.

14. A tool for extracting bearing cups from the wheel hub of a vehicle as described in claim 13, wherein the means for rotating the rod is a method selected from the group consisting of mechanical, electrical or hydraulic.

15. A tool for extracting bearing cups from the wheel hub of a vehicle as described in claim 1, further comprising a support bar installed on the rod and removably attached to the wheel hub from which the bearing cups are being extracted.

16. A tool for extracting bearing cups from the wheel hub of a vehicle, comprising:
a rod having an outer surface and first and second ends, wherein the rod is threaded in one direction at the first end and threaded in an opposite direction at the second end;
at least two extraction elements capable of being installed on opposite ends of the rod, each extraction element having:
an inner surface,
an outer surface,
an aperture formed in the center, the aperture having a threaded inner surface, and
at least one spring-loaded button which is capable of abutting against the internal surface of each bearing cup to be removed;
a means for rotating the rod such that the distance between the extraction elements installed on the rod is decreased; and
a means for rotating the rod such that the distance between the extraction elements installed on the rod is increased.

17. A tool for extracting bearing cups from the wheel hub of a vehicle, comprising:
a rod having an outer surface and first and second ends, wherein the rod is threaded in one direction at the first end and threaded in an opposite direction at the second end;
at least two extraction elements capable of being installed on opposite ends of the rod, each extraction element having:
an inner surface,
an outer surface,
an aperture formed in the center, the aperture having an inner surface,
a threaded nut installed in the aperture, and
at least one spring-loaded button which is capable of abutting against the internal surface of each bearing cup to be removed;
a means for rotating the rod such that the distance between the extraction elements installed on the rod is decreased; and
a means for rotating the rod such that the distance between the extraction elements installed on the rod is increased.

18. A tool for extracting bearing cups from the wheel hub of a vehicle, comprising:
a rod having an outer surface and first and second ends, wherein the rod is threaded in one direction at the first end and threaded in an opposite direction at the second end;
at least two extraction elements capable of being installed on opposite ends of the rod, each extraction element having:
an inner surface,
an outer surface,
an aperture formed in the center, the aperture having a threaded inner surface, and
at least one spring-loaded button which is capable of abutting against the internal surface of each bearing cup to be removed;
a support bar installed on the rod and removably attached to the wheel hub from which the bearing cups are being extracted;
a means for rotating the rod such that the distance between the extraction elements installed on the rod is decreased; and
a means for rotating the rod such that the distance between the extraction elements installed on the rod is increased.

19. A tool for extracting bearing cups from the wheel hub of a vehicle, comprising:
a rod having an outer surface and first and second ends, wherein the rod is threaded in one direction at the first end and threaded in an opposite direction at the second end;
at least two extraction elements capable of being installed on opposite ends of the rod, each extraction element having:
an inner surface,
an outer surface,
an aperture formed in the center, the aperture having an inner surface,
a threaded nut installed in the aperture, and
at least one spring-loaded button which is capable of abutting against the internal surface of each bearing cup to be removed;
a support bar installed on the rod and removably attached to the wheel hub from which the bearing cups are being extracted;
a means for rotating the rod such that the distance between the extraction elements installed on the rod is decreased; and
a means for rotating the rod such that the distance between the extraction elements installed on the rod is increased.

20. A tool for extracting bearing cups from the wheel hub of a vehicle, comprising:
a rod having an outer surface and first and second ends, wherein the rod is threaded in one direction at the first end and threaded in an opposite direction at the second end and wherein the rod has a first diameter at the first end and a second diameter at the second end and the first and second diameters are not equal;
at least two extraction elements capable of being installed on opposite ends of the rod, each extraction element having:
an inner surface,
an outer surface,
an aperture formed in the center, the aperture having an inner surface,
a threaded nut installed in the aperture, and
at least one spring-loaded button which is capable of abutting against the internal surface of each bearing cup to be removed;
a support bar installed on the rod and removably attached to the wheel hub from which the bearing cups are being extracted;
a means for rotating the rod such that the distance between the extraction elements installed on the rod is decreased; and
a means for rotating the rod such that the distance between the extraction elements installed on the rod is increased.
